(19) United States
(12) Patent Application Publication
(10) Pub. No.: US 2008/0074056 A1
(43) Pub. Date: Mar. 27, 2008

(54) Light controller

(76) Inventor: Wei-Hong Shen, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,905

(22) Filed: Sep. 22, 2006

(51) Int. Cl. H05B 41/36

(52) U.S. Cl. 315/291

(57) ABSTRACT

A light controller for controlling a correction operation for a traditional light module without influences from traditional lights is disclosed herein. The light controller includes a power system, a control unit, and at least one traditional light control module. The traditional light control module further includes a wave filter, a radiating unit, and a microprocessor. The traditional light control module is used for receiving an electronic control signal integrated by the power system and the control unit through the wave filter. The wave filter is configured to filter and output an electric signal and a control signal, wherein the radiating unit is configured to receive the electric signal for generating illumination, and the microprocessor is configured to decode the control signal for further controlling the operation of the radiating unit.

### BACKGROUND OF THE INVENTION

1. Field of the Invention

The present disclosure is related to a light controller and more particularly, to a light controller which controls a mixture of both traditional lights and Light Emitting Diodes (hereinafter referred to as LEDs).

2. Description of Related Art

Since the light bulb is was invented, the light bulb has already become one of the indispensable items in of everyday use for human life. Because the bulb has characteristics of convenience and apt to ease of use, it has already been widely applied to all kinds of fields by people inventors. For example, the typical family expenses include home lighting, goods commercial lighting, automobile lighting, outdoor advertising signboard or the display of traffic information including indicating lights, etc. However, with LED technology growing up improving quickly in recent years, lighting equipments like traditional bulbs or lamps are not as good efficient as LEDs in radiating power, installation time and power consumption, so now industry uses LEDs to replace traditional luminous light sources.

And Further to our understanding, a designing structure of for using the traditional bulbs and lamps in track lightings in the early radiating of stage is joins every each track light on the track by way of via a parallel connection, and every track light can be moved along the track for further changing its projecting angles. Thus the traditional bulbs and lamps can be disposed as one some partial lighting equipment. Wherein the necessary power is transmitted to every each track light by via the track, so that makes each track light give out emits light simultaneously to achieve lighting effect. In this design, every track light was is joined by way of via a parallel connection, so all track lights on the track keep maintain a the same basic operating principle of giving radiating luminance and shining simultaneously, resulting in the lighting track being unable to vary the intensity of different track lights. Furthermore, this design lacks the ability to control the shining sequences and time differences of each track light.

This problem can be overcome by conducting and utilizing LEDs because the electric characteristics of LEDs include being easy to achieve and control the setting and passing of the control signals, which are used for LEDs, via the track.

However, due to the lack of side direction astigmatism of LEDs, the reflex of the entirety of LED equipment is less obvious than traditional bulbs. As such, distribution of the light source array of LEDs needs to be scattered to comply even more with vision. In addition, a heat dispelling design is an important design point for LED equipment. In order that the general population comes to use LED equipment, two problems must firstly be overcome—a larger area of illumination must be possible, and it must be made easier for consumers to switch from traditional lamps and bulbs to LED equipment. In this sense LEDs are still unable to totally replace traditional bulbs and lights for the foreseeable future.

So, if we are to control LEDs and traditional lamps and bulbs simultaneously, both kinds of lighting equipment need to have the advantage of enhanced effects to form a light controlling device with the advantages of both traditional lighting forms and newer LED equipment. But because the control signal is transmitted with the electric signal simultaneously, traditional use of lamps and bulbs seriously disturbs the accuracy of setting up and transmitting the control signal. Obviously these drawbacks require improvements to be made to both LEDs and traditional lamps and bulbs in order to arrange and organize the control functions for them both simultaneously.

### SUMMARY OF THE INVENTION

For the above reasons, the present invention provides a light controller for controlling traditional lights and LEDs simultaneously and for letting the control signal control presentations of lighting order, lighting intensity as well as randomly switching light from each lighting source.

The light controller includes a power system, a control unit and at least one traditional light control module. The traditional light controlling module further includes a wave filter, a radiating unit and a microprocessor. The power system is configured to receive an external power and output an electric signal, and the control unit is configured to generate a control signal to the power system, wherein an electronic control signal is formed by the electric signal and the control signal. The traditional light control module is connected electrically to the power system for receiving an electronic control signal through the wave filter. The wave filter is configured to filter and output the electric signal and the control signal, the radiating unit is configured to receive the electric signal for generating illumination, and the microprocessor is configured to decode the control signal, which is filtered by the wave filter, for further controlling the operation of the radiating unit. Moreover, at least one LED control module is connected electrically to the power system to be mixed and controlled simultaneously via the electronic control signal.

More particularly, the present invention provides a traditional light control module for use in various kinds of light controllers. The traditional light control module comprises a wave filter, a radiating unit, and a microprocessor. The wave filter is configured to receive an electronic control signal and filter out an electric signal and a control signal. The radiating unit is configured to receive the electric signal for generating illumination, and the microprocessor is configured to decode the control signal, which is filtered by the wave filter, for further controlling the operation of the radiating unit

The general description above and the following details as well as the drawings are all used to further illustrate those manners, means, and efficacies employed in the present invention to achieve the desired purposes. Other purposes and advantages of the present invention will also be explained in the following descriptions and drawings.

### BRIEF DESCRIPTION OF THE DRAWINGS

Many aspects of the embodiments of the present disclosure can be better understood with reference to the following drawings. Like reference numerals designate corresponding parts throughout the several views.

FIG. 1 is a schematic block diagram of a light controller according to the present invention;

FIG. 2 is a schematic block diagram of a traditional light control module according to the present invention; and

FIG. 3 is a schematic wave diagram of an electronic control signal according to the present invention.

### DETAILED DESCRIPTION OF PREFERRED EMBODIMENTS

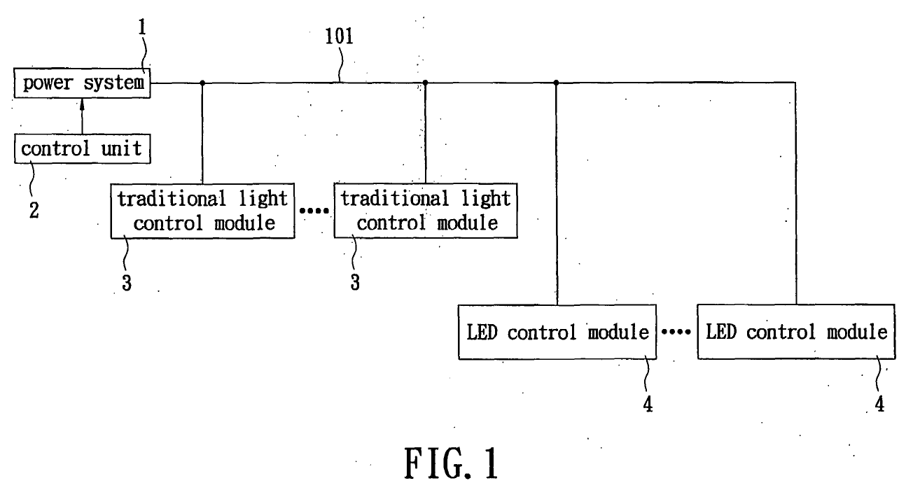

FIG. 1 is a schematic block diagram of a light controller according to the present invention. The light controller includes a power system 1, a control unit 2, at least one traditional light control module 3, and at least one LED control module 4. The power system 1 is configured to receive and transform an external power and then output an electric signal, wherein the external power may be a high voltage power or a low voltage power. The control unit 2 is configured to generate a control signal to the power system 1 in a wired or wireless manner, wherein an electronic control signal 101 is formed by the electric signal and the control signal. Moreover, the control unit 2 may accept indications from an external system (such as a computer, a cell phone, a personal digital assistant, etc) via an interface (not shown in the Figs.) to control the control signal, wherein the control signal may be formed by a packet format. Furthermore, the content in the packet format may comprise of relative information, such as beginning data, transferring data, allocation data, luminance data, illumination data or a moving distance, that is used to control the traditional light control module 3 and the LED control module 4 in the manner of lighting order, lighting intensity, projecting angles or moving allocations, etc. In a present practical operation, the power signal is a low frequency power signal, whereas the control signal is a high frequency control signal.

Both the traditional light control module 3 and the LED control module 4 connect electrically to the power system 1 to receive instructions and a power supply according to the electronic control signal 101, which is outputted by the power system 1, wherein the electronic control signal 101 may be transferred to the traditional light control module 3 and the LED control module 4 by at least two control lines in a practical operation. Furthermore, the control lines may be applied to a practical track to form a track light design for controlling movements of lighting equipment to different locations easily.

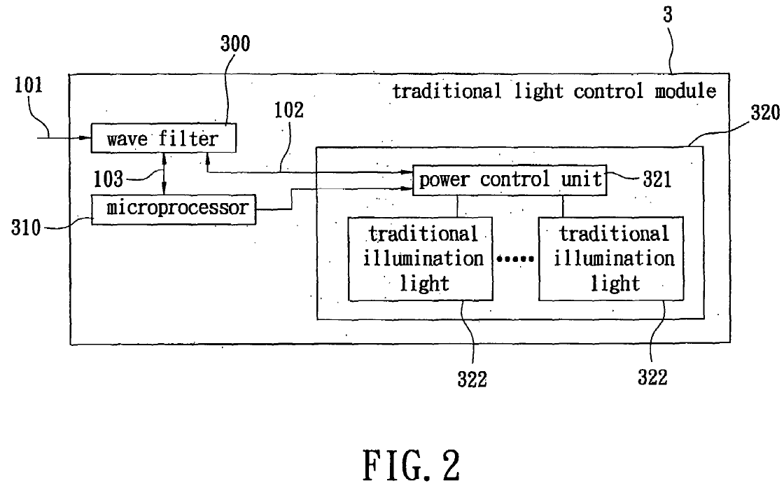

Please refer to FIG. 1 and FIG. 2, wherein FIG. 2 is a schematic block diagram illustrating a traditional light control module according to the present invention. As shown in the figures, the traditional light control module 3 further includes a wave filter 300, a radiating unit 320, and a microprocessor 310. The wave filter 300 is configured to receive the electronic control signal 101 outputted from the power system 1 and filter the electronic control signal 101 for further outputting the electric signal 102 and the control signal 103, wherein the filtering manner in the wave filter 300 may be a manner of impedance matching. For example, it might be in a low frequency power signal loading situation (i.e. 50 or 60 Hz) in order to make the impedance from the impedance matching be relatively low, whereas it might be in a high frequency control signal non-loading situation (i.e. 115 KHz) in order to make the impedance from the impedance matching be relatively high. In this manner, the control signal 103 will not vanish when there is a disturbance from the traditional light control module 3.

The microprocessor 310 is configured to decode the control signal 103, which is filtered by the wave filter 300, which then processes original user inputting data of the control signal 103 for further controlling the operation of the radiating unit. The radiating unit 320 comprises at least one traditional illumination light 322 and a power control unit 321, wherein the power control unit 321 is configured to receive the power signal 102 for providing a required power to the traditional illumination light 322 when the traditional illumination light 322 generates light. Furthermore, the power control unit 321 may accept instructions from the microprocessor for changing the radiating effect and the operating status of the traditional illumination light 322. The traditional illumination light 322 may be an aero-discharging lamp, a tungsten filament light bulb, a haloid light bulb, or a filament light bulb, etc. Moreover, because the starters or controllers required for different bulbs and lamps are not quite the same, the power control unit 321 can change selections according to different traditional illumination lights.

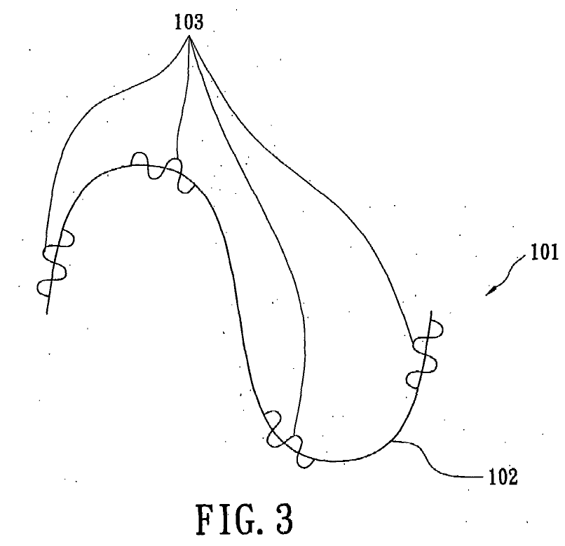

The schematic wave diagram of the above-mentioned electronic control signal 101 may be shown as in FIG. 3. The wave form of the electronic control signal 101 comprises the electric signal 102 and the control signal 103, which are integrated together, so as to not only provide the required power but also control the radiating models for the traditional light control module 3 and the LED control module 4 simultaneously. Furthermore, the beginning data, transferring data, allocation data, luminance data, illumination data and moving distance which are in the above-mentioned packet format may have specific meanings. For example, the beginning data indicates a starting point of the control signal 103, the transferring data indicates the beginning of data transferal and accordingly determines if the control signal 103 is a valid signal or not. The allocation data indicates which light source can be controlled by the control signal 103, the luminance data is used to control the luminance of each light source, and the illumination data and moving distance are used to control illumination angles and required moving distances of the light sources, respectively.

As described above, the light controller of the present invention mainly controls the LED control modules 4 but is also capable of mixing general traditional light control modules 3, and, furthermore, the control signal 3 is not disturbed because of the mixture. Based on the above features, the present invention not only controls the light sources in order presentations, lighting intensity and random changes, but also increases the overall flexibility and adaptive fields of the light controller.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A light controller comprising:
a power system configured to receive and transform an external power and output an electric signal;
a control unit configured to generate a control signal to the power system, wherein an electronic control signal is formed by the electric signal and the control signal; and
at least one traditional light control module configured to connect electrically to the power system, the traditional light control module comprising:
a wave filter configured to receive and filter the electronic control signal and output the electric signal and the control signal;
a radiating unit configured to receive the electric signal for generating a illumination light; and
a microprocessor configured to decode the control signal filtered from the wave filter for further controlling the operation of the radiating unit.

2. The light controller of claim 1, wherein the external power is a high voltage power or a low voltage power.

3. The light controller of claim 1, wherein the control unit outputs the control signal to the power system in a wired or wireless manner.

4. The light controller of claim 1, wherein the control signal is formed by a packet format.

5. The light controller of claim 4, wherein content in the packet format comprises beginning data, transferring data, allocation data, luminance data, illumination data, and a moving distance.

6. The light controller of claim 1, wherein the power signal is a low frequency power signal, and the control signal is a high frequency control signal.

7. The light controller of claim 1, wherein the electronic control signal transferred to the traditional light control module via at least two control lines.

8. The light controller of claim 7, wherein the control lines are applied to a track.

9. The light controller of claim 1, wherein the electronic control signal controls the traditional light control module and an LED control module simultaneously.

10. The light controller of claim 1, wherein the wave filter filters and outputs the power signal and the control signal by a method of impedance matching.

11. The light controller of claim 1, wherein the radiating unit comprises:
at least one traditional illumination light; and
a power control unit configured to accept controls from the microprocessor for changing the radiating effect of the traditional illumination light.

12. The light controller of claim 11, wherein the traditional illumination light is an aero-discharging lamp, a tungsten filament light bulb, a haloid light bulb, or a filament light bulb.

13. A traditional light control module which is applied to a light controller, the traditional light control module comprising:
a wave filter configured to receive an electronic control signal and filter out the electric signal and the control signal from the electronic control signal;
a radiating unit configured to receive the electric signal for generating a illumination light; and
a microprocessor configured to decode the control signal filtered by the wave filter for further controlling the operation of the radiating unit.

14. The traditional light control module of claim 13, wherein the wave filter filters out the power signal and the control signal by a method of impedance matching.

15. The traditional light control module of claim 13, wherein the control signal is formed by a packet format.

16. The traditional light control module of claim 13, wherein the radiating unit comprises:
at least one traditional illumination light; and
a power control unit configured to accept controls from the microprocessor for changing the radiating effect of the traditional illumination light.

17. The traditional light control module of claim 16, wherein the traditional illumination light is an aero-discharging lamp, a tungsten filament light bulb, a haloid light bulb, or a filament light bulb.
